(19) United States
(12) Patent Application Publication
(10) Pub. No.: US 2026/0153618 A1
(43) Pub. Date: Jun. 4, 2026

(54) AXIAL OFFSET DETERMINATION DEVICE AND AXIAL OFFSET DETERMINATION METHOD

(71) Applicant: Hitachi Astemo, Ltd., Hitachinaka-shi, Ibaraki (JP)

(72) Inventors: Nobuyuki TAKAYA, Hitachinaka-shi, Ibaraki (JP); Hiroshi KURODA, Hitachinaka-shi, Ibaraki (JP); Yukinobu TANAKA, Hitachinaka-shi, Ibaraki (JP)

(73) Assignee: Hitachi Astemo, Ltd., Hitachinaka-shi, Ibaraki (JP)

(21) Appl. No.: 18/704,010

(22) PCT Filed: Jul. 29, 2022
(86) PCT No.: PCT/JP2022/029251

§ 371 Date: Apr. 23, 2024

(30) Foreign Application Priority Data
Oct. 25, 2021 (JP) 2021-173803

(51) Int. Cl. G01S 13/931; G01S 13/58

(52) U.S. Cl. CPC G01S 13/931; G01S 13/58; G01S 2013/9327

(57) ABSTRACT

To provide an axial offset determination device in which an axial offset of a radar is determinable even when an offset angle of a door mirror built-in radar becomes large and a side surface of a host vehicle does not enter a detection range of the radar, the axial offset of the radar is determinable. The object detection unit that is attached to a vehicle, transmits a transmission wave to the surroundings, and detects a detection point on an object that reflects the transmission wave based on a reflection wave reflected by the object; and a determination unit that sets a predetermined region as a host-vehicle region where the vehicle is present in a detection range of the object detection unit and determines an axial offset of the object detection unit based on a detection result of the detection point within the host-vehicle region when detecting the detection point within the host vehicle region.

### TECHNICAL FIELD

The present invention relates to an axial offset determination device and an axial offset determination method to determine an axial offset of a door mirror built-in radar that monitors a side and rear of a host vehicle.

### BACKGROUND ART

In recent, automobiles that mount the Advanced Driver Assistance System (ADAS) or the Autonomous Driving (AD) system are increasing. The Advanced Driver Assistance System provides an alert to a driver or assists driving in response to conditions of an obstacle and a moving object around a host vehicle. In addition, the Driver Assistance System is a system that automatically controls acceleration and deceleration, steering, etc. of the host vehicle in response to conditions of an obstacle and a moving object around the host vehicle. Then, any of the systems includes sensors for detecting an environment around the host vehicle, such as a camera, LiDAR, and a radar.

As a conventional technology that monitors the right, left, and rear of a host vehicle by use of a radar, a vehicle radar device of Patent Literature 1 is known. For example, the abstract of the literature describes that a subject is “to provide a vehicle radar device to improve a detection accuracy of a door mirror built-in radar sensor,” and describes, as a solution, that “a vehicle radar device that is mounted to a vehicle to detect objects around the host vehicle has a radar sensor attached to the host vehicle to make at least part of the body of the host vehicle enter the detection range, a position where at least the part of the body of the host vehicle detected by the radar sensor extends is set as a reference position, and when an object around the host vehicle is detected by the radar sensor, an existence direction of the object is detected as an offset angle from the reference position.”

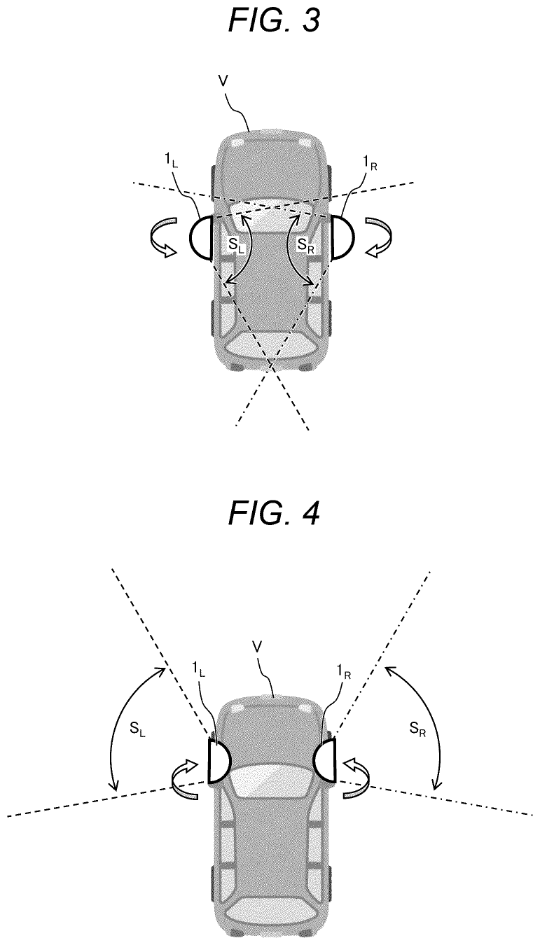

That is, in the vehicle radar device of Patent Literature 1, as explained in FIG. 3 and FIG. 4 in this literature, under the condition that at least the part of the body of the host vehicle enters the detection range of the radar sensor and the object around the host vehicle also enters the detection range of the radar sensor, the offset angle from the reference position of the radar sensor is detectable.

### CITATION LIST

### Patent Literature

Patent Literature 1: Japanese Unexamined Patent Application Publication No. 2009-20076

### SUMMARY OF INVENTION

### Technical Problem

However, the vehicle radar device of Patent Literature 1 has a problem that, when the offset angle of the radar becomes large and the body of the host vehicle does not enter the detection range or in contrast, when the object around the host vehicle does not enter the detection range, the offset angle of the radar is undetectable. That is, the problem is that, only in the environment in which both the body of the host vehicle and the object around the host vehicle enter the detection range, the axial offset is detectable.

Thus, an object of the present invention is to provide an axial offset determination device and axial offset determination method in which an axial offset of a radar is determinable even when an offset angle of a door mirror built-in radar becomes large and a side surface of a host vehicle does not enter a detection range of the radar, the axial offset of the radar is determinable.

### Solution to Problem

For addressing the above problem, an axial offset determination device of the present invention includes: an object detection unit that is attached to a vehicle, transmits a transmission wave to the surroundings, and detects a detection point on an object that reflects the transmission wave based on a reflection wave reflected by the object; and a determination unit that sets a predetermined region as a host-vehicle region where the vehicle is present in a detection range of the object detection unit and determines an axial offset of the object detection unit based on a detection result of the detection point within the host-vehicle region when detecting the detection point within the host vehicle region.

### Advantageous Effects of Invention

According to an axial offset determination device or an axial offset determination method, even when an offset angle of a door mirror built-in radar becomes large and a side surface of a host vehicle does not enter a detection range of the radar, an axial offset of the radar is determinable. Brief Description of Drawings

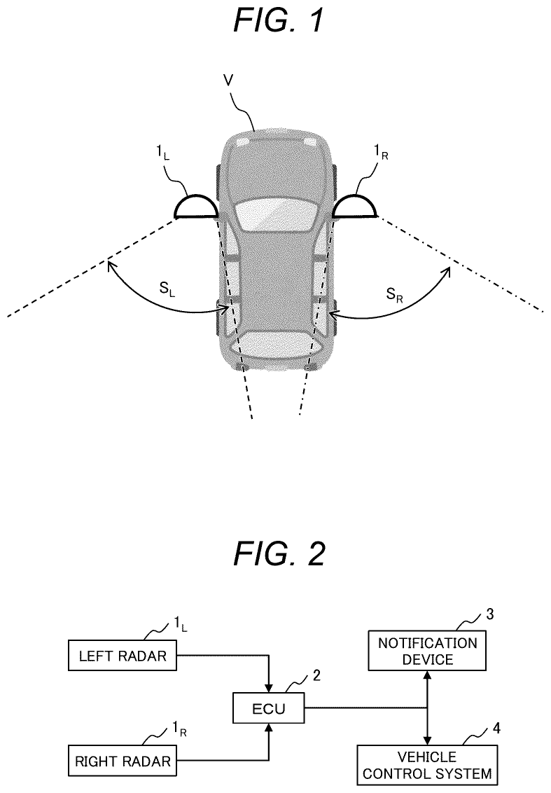

FIG. 1 is a top view when a radar of an embodiment is deployed.

FIG. 2 is a schematic configuration of a vehicle system of an embodiment.

FIG. 3 is a top view of a host vehicle when a radar of an embodiment is folded rearward.

FIG. 4 is a top view of a host vehicle when a radar of an embodiment is folded forward.

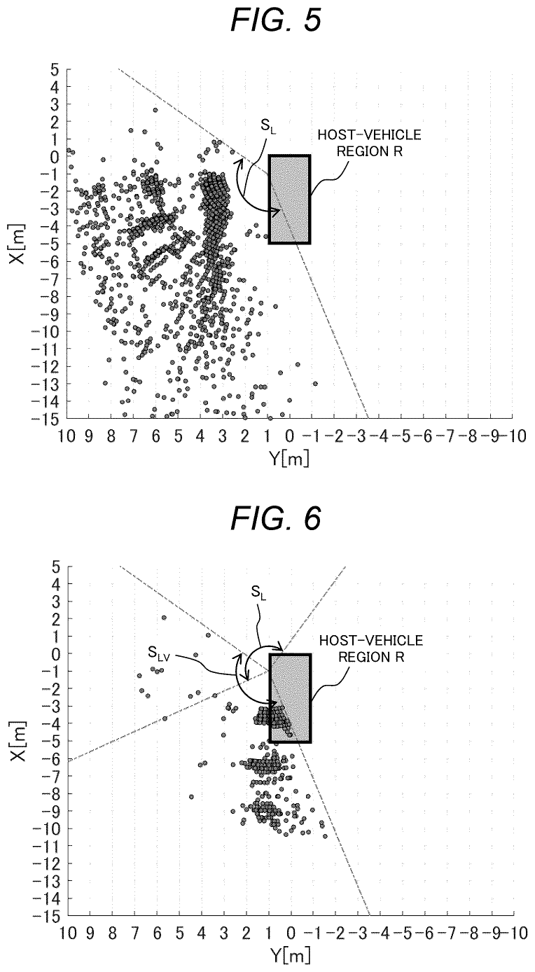

FIG. 5 is a plot of detection points detected by a left radar in a deployed state while a host vehicle is stopped.

FIG. 6 is a plot of detection points falsely detected by a left radar in a forward folded state while a host vehicle is stopped.

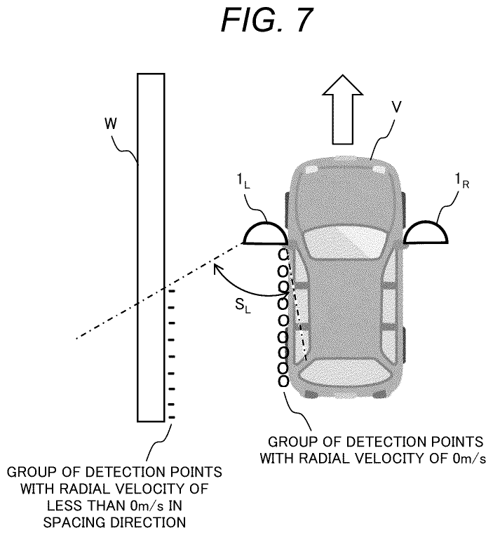

FIG. 7 is a top view of detection points detected by a left radar in a deployed state.

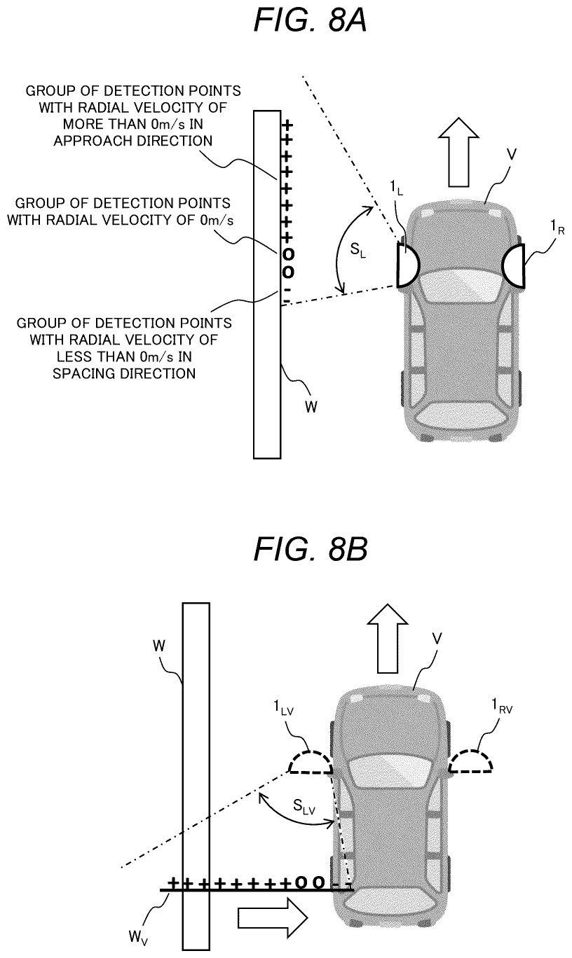

FIG. 8A is a top view of detection points detected by a left radar in a forward folded state.

FIG. 8B is a top view of detection points falsely detected by the left radar of FIG. 8A.

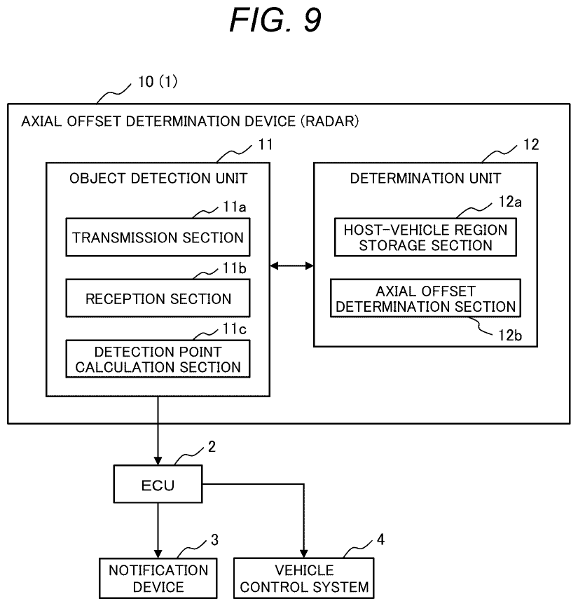

FIG. 9 is a function block diagram of an axial offset determination device of an embodiment.

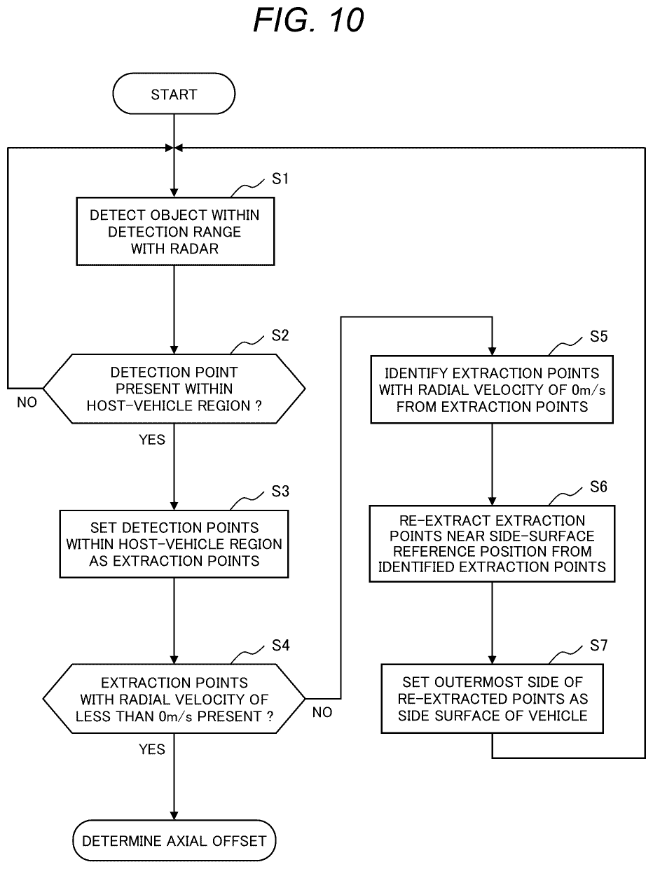

FIG. 10 is a flowchart of processes of an axial offset determination device of an embodiment.

### DESCRIPTION OF EMBODIMENTS

Hereinafter, by use of the drawings, one embodiment of an axial offset determination device 10 of the present invention is explained.

FIG. 1 is a top view of a host vehicle V when a door mirror built-in radar of the present embodiment (hereinafter called just a “radar 1”) is in the deployed state. This radar 1 is a sensor that transmits transmission waves to the surroundings and detects detection points on an object reflecting the transmission waves based on reflection waves reflected by the object. In the host vehicle V of the present embodiment, a left door mirror contains a left radar 1_{L} that detects a range from the left to the left rear, and a right door mirror contains a right radar 1_{R} that detects a range from the right to the right rear. It is noted that the detection range of the left radar 1_{L} illustrated by the broken line is called a left detection range S_{L}, and the detection range of the right radar 1_{R} illustrated by the dash-dotted line is called a right detection range S_{R}.

FIG. 2 is a schematic configuration diagram of a vehicle system for achieving the above ADAS and AD in the host vehicle V. As illustrated here, the detection points that are outputs of the left radar 1_{L} and the right radar 1_{R} are inputted into an ECU 2 (Electronic Control Unit). Based on detection point information (information about a position or radial velocity of each detection point) inputted from each radar, the ECU 2 detects obstacles and moving bodies around the host vehicle and determines a possibility of contact between a detected obstacle etc. and the host vehicle V. Then, when an obstacle etc. is detected, the driver is notified of the presence of the obstacle etc. via a notification device 3, and when it is determined that there is a possibility of contact, a vehicle control system 4 is controlled to cause the host vehicle V to use automatic braking or automatic steering to avoid the contact.

Here, many vehicles in recent years are equipped with a function for automatically folding door mirrors to make a vehicle width as narrow as possible at the time of parking and passing through a narrow passage etc. As a system for folding door mirrors, the rearward folding system used in many small vehicles such as standard automobiles and the forward folding system used in many large vehicles such as trucks are known. It is noted that details of the present invention are explained hereinafter on the assumption that any of the door mirror folding systems is mounted to a standard automobile.

FIG. 3 is a top view illustrating a radar folded state in the host vehicle V using a rearward folding type door mirror. In this case, as a result of folding the left radar IL counterclockwise and folding the right radar 1R clockwise, the left and right radars are respectively covered with the vehicle side surfaces, and objects around the host vehicle become undetectable. Thus, an axial offset of the radar is undetectable in the disclosed technology of Patent Literature 1 in which an axial offset of a radar is detectable only when a host vehicle and an object around the host vehicle are both within the detection range.

In contrast, FIG. 4 is a top view illustrating a radar folded state in the host vehicle V using a forward folding type door mirror. In this case, as a result of folding the left radar 1_{L} clockwise and folding the right radar 1R counterclockwise, each detection range of the left and right radar faces outward of the vehicle and it becomes difficult to detect the host vehicle. Therefore, an axial offset of the radar is undetectable using the disclosed technology of Patent Literature 1.

However, by using the axial offset determination method of the present invention, even in the radar folded state as in FIG. 4, a large axial offset of each radar is determinable. Hereinafter, details of the axial offset determination method of the present invention are explained sequentially.

### Specific Example of Detection Points Detected by Radar 1 During Stop

First, by use of FIG. 5 and FIG. 6, a difference between the detection points detected by the left radar 1_{L} in the deployed state and the detection points detected by the left radar 1_{L} in the forward folded state is explained.

FIG. 5 is a plot specifically illustrating the detection points detected by the left radar 1_{L} while the host vehicle V is stopped in a certain environment. In this plot, the front center of the host vehicle V is the starting point of the XY coordinate system, the forward direction of the host vehicle V is the positive direction of the X axis, and the left direction of the host vehicle V is the positive direction of the Y axis. The left radar 1_{L} of the present embodiment locates each detection point around the host vehicle on the assumption that the left radar 1_{L} is in the deployed state. In FIG. 5, the real pose (deployed state) of the left radar 1_{L} matches the above assumption (deployed state). Thus, the left radar 1_{L} is capable of locating each detection point to an original position within the left detection range S_{L} in the deployed state. The abnormality that the detection points are located within a region where the host vehicle V exists (hereafter called a “host-vehicle region R”) does not occur.

In contrast, FIG. 6 is a plot specifically illustrating the detection points detected by the left radar 1_{L} in the forward folded state (see FIG. 4) while the host vehicle V is stopped in another environment. Also in this case, the left radar 1_{L} locates each point around the host vehicle on the assumption that the left radar 1_{L} is in the deployed state. In FIG. 6, the real pose of the left radar 1_{L} (forward folded state) does not match the above assumption (deployed state). In this case, since the left radar 1_{L} locates each detection point within a left detection range Siv corresponding to the deployed state instead of an original position (within the left detection range S_{L} corresponding to the forward folded state), the detection points are abnormally located within the host-vehicle region R where the detection points should not be present originally.

### Example of Detection Points Detected by Radar 1 During Slow Advance

Next, by use of FIG. 7 and FIGS. 8A, 8B, during slow advance of the host vehicle V, a difference between the detection points detected by the left radar 1_{L} in the deployed state and the detection points detected by the left radar 1_{L} in the forward folded state is explained.

FIG. 7 is a top view illustrating the detection points detected at a left wall W and the left side surface of the host vehicle V by the left radar 1_{L} (see FIG. 1) in the deployed state in the environment that the host vehicle V is slowly advancing along the left wall W. In this case, there are two types of detection points including a detection point group in the spacing direction seen from the left radar 1L (the minus marks in the figure) and a detection point group having an unchanged distance seen from the left radar 1_{L} (the circle marks in the figure). Thus, the ECU 2 that has received outputs from the left radar 1_{L} is capable of distinguishing between the detection points on the object (wall W) in the left direction of the host vehicle and the detection points on the side surface of the host vehicle.

In contrast, FIG. 8A is a top view illustrating an original arrangement of the detection points detected on the left wall W by the left radar 1_{L} in the forward folded state (see FIG. 4) in the environment that the host vehicle V is slowly advancing along the left wall W. In this case, there are three types of detection point groups including a detection point group in the approaching direction seen from the left radar 1_{L} (the plus marks in the figure), a detection point group having an unchanged distance seen from the left radar 1_{L} (the circle marks in the figure), and a detection point group in the spacing direction seen from the left radar 1_{L} (the minus marks in the figure). On the assumption that the left radar 1_{L} is in the forward folded state, the ECU 2 that has received outputs from the left radar 1_{L} should be able to determine that each detection point is on the object (wall W) in the left direction of the host vehicle based on a distance and direction of each detection point and a radial velocity of each detection point.

However, as explained in FIG. 6, since the left radar 1_{L} processes the detection points on the assumption that the left radar 1_{L} is in the deployed state, the left radar 1_{L} misunderstands that the detection point group that is to be in the original positions illustrated in FIG. 8A is present at the positions illustrated in FIG. 8B. As a result, the ECU 2 that has received outputs from the left radar 1_{L} (false detection point group illustrated in FIG. 8B) falsely detects an object moving in the left to right direction of the host vehicle V (virtual wall W_{V}), the object being originally not present.

Here, it is obvious as in FIG. 8B that the detection point group located at false positions when the left radar li is in the forward folded state has the following features. That is, first, part of the detection point group is present inside the host-vehicle region R. Second, the detection point group inside the host-vehicle region R has a radial velocity (radial velocity<0 m/s) in the spacing direction seen from the left radar 1_{L}. Therefore, when the detection point group satisfying such two conditions is detected during slow advance of the host vehicle V, a large axial offset of the radar 1, which is difficult to be detected using the disclosed technology of Patent Literature 1, can be determined to occur. On contrast, when a detection point satisfying such two conditions does not exist, it can be determined that no large axial occurs.

### Details of Axial Offset Determination Device 10

Next, by use of a functional block diagram of FIG. 9 and a flowchart of FIG. 10, the axial offset determination device 10 of the present embodiment is explained. It is noted that the axial offset determination device 10 of the present embodiment is a name to pay attention to an axial offset determination function. The radar 1 and axial offset determination device 10 are actually the same device.

As in FIG. 9, the axial offset determination device 10 has an object detection unit 11 and a determination unit 12, and outputs a detection point group detected by the object detection unit 11 to the ECU 2. In addition, the object detection unit 11 has a transmission section 11a, a reception section 11b, and a detection point calculation section 11c. The determination unit 12 has a host-vehicle region storage section 12a and an axial offset determination section 12b. It is noted that the configuration of the axial offset determination device 10 except for the transmission section 11a and reception section 11b is specifically a computer having a calculation device such as a CPU, a storage device such as a semiconductor memory, and hardware such as a communication device. Then, the calculation device executes a predetermined program to achieve each function of the above detection point calculation section 11c etc. Hereinafter, while explanation for such known technologies in the computer field is appropriately omitted, details of each section is sequentially explained.

The transmission section 11a is a transmission antenna that transmits transmission waves to the surroundings of the host vehicle. The reception section 11b is a reception antenna that receives reflection waves reflected by objects. It is noted that detailed configurations of these antennas and control methods of the transmission and reception are known, and thus are not explained in detail.

Based on reflection waves received by the reception section 11b, the detection point calculation section 11c locates detection points for an object within the detection range of the radar 1 and calculates a radial velocity of each detection point seen from the radar 1. Thus, within the detection range on the assumption that the radar 1 is in the deployed state, various types of the detection point groups (the minus marks, circle marks, and plus marks in the figure) as illustrated in FIG. 7 and FIG. 8B are located.

The host-vehicle region storage section 12a is a storage section that stores the shape of the host-vehicle region R illustrated in FIG. 5 and FIG. 6 and attachment positions of the left and right radars in the host-vehicle region R. It is noted that the host vehicle region R etc. stored herein may be a previously registered shape of the host vehicle V or may be a later registered shape of the host vehicle estimated from the side surface shape of the host vehicle V by the radar 1.

The axial offset determination section 12b determines that, when the detection points located by the detection point calculation section 11c and the host-vehicle region R stored in the host vehicle region storage section 12a satisfy the above two conditions, a large axial offset that is undetectable using the disclosed technology of Patent Literature 1 occurs.

Here, by use of the process flowchart of FIG. 10, axial offset determination processes using the axial offset determination device 10 of the present embodiment (especially, the determination unit 12) are explained in detail.

First, at Step S1, after receiving a reflection wave from an object within a detection range of the radar 1 by use of the transmission section 11a and reception section 11b, the object detection unit 11 locates detection points for the object within the detection range by use of the detection point calculation section 11c on the assumption that the radar 1 is in the deployed state.

Next, at Step S2, the determination unit 12 determines whether the detection points are located within the host-vehicle region R stored in the host-vehicle region storage section 12a. Then, when the detection points are present within the host vehicle region R, the flow proceeds to Step S3, and when the detection points are not present, the flow returns to Step S1.

At Step S3, the determination unit 12 sets the detection points within the host-vehicle region R as extraction points.

At Step S4, the determination unit 12 determines whether an extraction point having a radial velocity less than 0 m/s is present, that is, whether a detection point in the spacing direction seen from the radar 1 is present within the host vehicle region R. When the extraction point satisfying the condition is present, a large axial offset that is undetectable using the disclosed technology of Patent Literature 1 is determined to occur. In this case, the ECU 2 may also use outputs of the radar 1 on the assumption that a large axial offset is present. In contrast, when an extraction point satisfying the condition is not present, the flow proceeds to Step S5.

Here, in the axial offset determination method of the present invention, a reason that the determination at Step S4 is executed in addition to the determination at Step S2 is explained. When FIG. 8A and FIG. 8B are compared to each other, by use of only the determination of whether the detection point is present within the host-vehicle region R, that is, by use of only the execution of the determination at Step S2, the presence of a large axial offset may be determined. However, under the situation of FIG. 7 where a large axis offset does not occur, the detection point group (the circle marks in the figure) that is observed on the left surface of the host vehicle and has an unchanged distance seen from the left radar 1_{L} would be located along the left side surface of the host-vehicle region R theoretically. However, in actual, part of the detection points may be located also within the host-vehicle region R due to a measurement error etc. Then, in this case, based on only the determination at Step S2, a large axial offset is misunderstood as occurring despite that no large axial offset occurs. Thus, it is difficult to correctly determine the presence of a large axial offset only by the determination at Step S2. Therefore, in the present embodiment, in addition to the determination at Step S2, the determination at Step S4 is executed to correctly determine the presence of a large axial offset.

The processes from Step S5 to Step S7 are useful, for example, when the host-vehicle region R is not registered to the host-vehicle region storage section 12a. First, at Step S5, the detection point calculation section 11c identifies an extraction point having a radial velocity of 0 m/s (see the circle marks of FIG. 7) from the extraction points. Next, at Step S6, the detection point calculation section 11c re-extracts extraction points near the side surface reference position from the identified extraction points. Lastly, at step S7, the detection point calculation section 11c sets the outermost side of the re-extracted points as the side surface of the vehicle, and registers this side surface to the host-vehicle region storage section 12a as the host-vehicle region R. Through these processes, even when the host-vehicle region R is unregistered to the host-vehicle region storage section 12a or even when the host-vehicle region R registered to the host vehicle region storage section 12a is false, the host-vehicle region R appropriate in response to an actual situation is capable of being registered to the host-vehicle region storage section 12a based on a measurement result of the radar 1. It is noted that a radial velocity of the detection point on the host-vehicle side surface may not be 0 m/s due to a measurement error etc. Thus, at Step S5, for example, extraction points with a radial velocity falling between ±0.1 m/s may be selected.

### Advantageous Effects of Present Embodiment

According to the axial offset determination device or axial offset determination method of the present embodiment explained above, even when the offset angle of the radar sensor becomes large and the host-vehicle side surface does not enter the detection range of the radar, the axial offset of the radar is determinable based on radial velocities of the detection points within the host-vehicle region.

REFERENCE SIGNS LIST

V: host vehicle, 1: radar, 1_{L}: left radar, S_{L}: left detection range, 1R: right radar, S_{R}: right detection range, 2: ECU, 3: notification device, 4: vehicle control system, 10: axial offset determination device, 11: object detection unit, 11a: transmission section, 11b: reception section, 11c: detection point calculation section, 12: determination unit, 12a: host-vehicle region storage section, 12b: axial offset determination section, W: wall, Wy: virtual wall

1. An axial offset determination device comprising:
an object detection unit that is attached to a vehicle, transmits a transmission wave to surroundings, and detects a detection point on an object reflecting the transmission wave based on a reflection wave reflected by the object; and
a determination unit that sets a predetermined region as a host-vehicle region where the vehicle is present within a detection range of the object detection unit and determines an axial offset of the object detection unit based on a detection result of the detection point within the host-vehicle region when detecting the detection point within the host-vehicle region.

2. The axial offset determination device according to claim 1 wherein
the host-vehicle region is registered to the determination unit in advance.

3. The axial offset determination device according to claim 1 wherein
the determination unit sets the host-vehicle region in the detection range in response to a detection result of a side surface of the vehicle, the side surface being detected by the object detection unit.

4. The axial offset determination device according to claim 1 wherein
the object detection unit determines a radial velocity of the detection point relative to the object detection unit, and
the determination unit determines an axial offset of the object detection unit based on the radial velocity of the detection point within the host-vehicle region.

5. An axial offset determination method comprising:
a step of transmitting a transmission wave to surroundings and detecting a detection point on an object reflecting the transmission wave based on a reflection wave reflected by the object by use of an object detection unit attached to a vehicle, and
a step of setting a predetermined region as a host-vehicle region where the vehicle is present, and determining an axial offset of the object detection unit based on a detection result of the detection point within the host-vehicle region when the detection point is detected within the host-vehicle region.
